(19) United States
(12) Patent Application Publication
(10) Pub. No.: US 2011/0150613 A1
(43) Pub. Date: Jun. 23, 2011

(54) Integrated Boom/Underlift Assembly and Support Device

(76) Inventor: David How-Hwa Hwang, Seattle, WA (US)

(21) Appl. No.: 12/766,675

(22) Filed: Apr. 23, 2010

(30) Foreign Application Priority Data
Dec. 22, 2009 (CN) 200910265675.8

(51) Int. Cl. B66C 23/36; B60P 3/12; B60P 3/07

(52) U.S. Cl. 414/563; 212/294

(57) ABSTRACT

The present invention provides an integrated boom/underlift assembly in which an underlift is integrated to a first section of a boom. In order to achieve multifunction of the assembly, the underlift/vertical arm assembly is installed with a hydraulic cylinder, an auxiliary winch, a guide pulley, etc. so that the underlift can be operated independently and work closely with the boom to increase both stability and balance during the lifting operation. Additionally, the invented underlift can extend a much longer distance at a higher position than those currently in the art to catch a wrecked object and then works together with the boom.

### BACKGROUND OF THE INVENTION

1. Field of the Invention

The present invention provides a boom/underlift assembly in which an underlift is integrated to a first section of a boom. In order to achieve multifunction, the underlift is specifically designed so that it can work with the boom simultaneously to increase both stability and balance during a lifting operation.

The present invention also includes a support device to hold up the boom/underlift assembly. The support device acts as a fulcrum which is relocated from the end of a sub-frame to a preferable position. Such a preferable location greatly increases the degree of balance in the leverage function. Consequently, it improves the load distribution on sub-frames of a wrecker during transportation with a wrecked object.

2. Description of the Related Art

Nowadays, a traditional street wrecker generally has two ordinary functions: the first is to lift up a wrecked object with an underlift, fix it at the underlift and then moving such wrecked object out of a major traffic artery; and the next is to hang up a wrecked object with a boom and transfer it to a new site suitable for the successive operations. Basically, the above two functions are not related to each other, so safety problems may easily occur while someone is trying to increase its working capacity into one street wrecker without a strong structural support. When an operator uses the boom equipped on a street wrecker to lift up a wrecked object, the usual accidents comprise: the segment of the boom that has been stretched out to the most remote position may break easily; the street wrecker may swerve off the road into the ditch or the wrecked object on a steep slope may easily be damaged again due to the rollover or sideslip.

Underlifts of almost all wreckers are fastened rigidly with the end of sub-frame, and the wrecked object is raised up primarily by the underlift. Under this circumstance, the rear end of sub-frame is subjected to a high stress, and such a high stress is sustained during a long transportation process. Consequently, the rear driving wheels are working under the greatest pressure which accelerates wear of the tires, and the front wheel of the vehicle will be raised up due to the leverage function, under this circumstance, it has to add a more heavier corner weight to the front portion of the vehicle in order to maintain the balance of a vehicle. Nevertheless, it seems a little bit difficult to drive a heavy weight street wrecker under an unbalanced condition while it is not carrying any wrecked object.

Towing equipment industries have confronted an overloaded problem for years as operating the heavy duty rotator. The heavy duty towing truck has rear outrigger, vertical arm and underlift assemblies attached to the rear of sub-frame together with towing a wrecked vehicle. As a result, the truck that sometimes exceeds legal load limits certainly damages both roads and bridges. This overweight truck may not be allowed to perform the transportation job even if it is an emergency case. However, a special permit may be issued in order to do such a job depending on individual case.

### SUMMARY OF THE INVENTION

The present invention provides an integrated boom/underlift assembly in which an underlift is integrated to a first section of a boom. In order to achieve multifunction of the assembly, the underlift/vertical arm assembly is installed with a hydraulic cylinder, an auxiliary winch, a guide pulley and etc so that the underlift can be operated independently and then works closely with the boom to increase both stability and balance during the lifting operation. Additionally, the invented underlift can extend a much longer distance at higher position than the current one to catch a wrecked object and then works together with the boom.

Another aspect of the present invention is to provide a support device to hold up the boom/underlift assembly. The support device locates at a preferable spot, i.e., intersection of the centerline of the last two wheels and the centerline of tailboard of a street wrecker. The support device acts as a fulcrum which is relocated from the end of sub-frame to a preferable position. Such a favorable change greatly increases the degree of balance in the leverage function and thus improves stress distribution on sub-frames as the underlift is loaded with a wrecked object. This result is able to decrease or eliminate the corner weight at the front end of a vehicle, and also reduces the stress and wear on rear driving wheels as well as extends overall service life of a wrecker.

In order to achieve the above-mentioned goals, the present invention, therefore, adopts the advanced technology solutions described as follows.

It may comprise one boom assembly, one hydraulic winch system, one vertical arm assembly, one underlift assembly, one support device and one hydraulic cylinder system, wherein:

A stretchable first inner boom (second section) and second inner boom (third section) is installed respectively inside of outer boom (first section), the boom assembly, and the vertical arm assembly having height adjustable type vertical arm is welded at the end of the first section of the boom assembly.

The underlift assembly, which is fastened at the vertical arm assembly, has three stage arms including the first inner arm (second section) and the secondary inner arm (third section); an auxiliary hydraulic winch system consists of one cross bar, which is fixed at the end of the underlift assembly, and each side of the cross bar on auxiliary lifting hooks has been equipped with one guide pulley and hydraulic winch, respectively.

There are wire ropes passing through the auxiliary hydraulic winch system, guide pulleys and auxiliary lifting hooks, and wherein, the hydraulic cylinder system consists of a plurality of hydraulic cylinders that have been installed inside the boom assembly, the vertical arm assembly and the underlift assembly respectively, and in this way it will be able to functionally activate and control the operations of extending outward or retracting inward for the relevant operational arms accordingly.

A support device, which is used to support the boom/underlift assembly, is equipped at a preferable location. It acts as a fulcrum which is relocated from the end of sub-frame to a preferable position. This preferable location greatly increases the degree of balance in the leverage function, and accordingly improves the load distribution on sub-frames of a wrecker.

The present invention has changed the mechanical structure of traditional boom, and thereat, it utilizes the lifting function of the two-section vertical arm to support the wrecked object and distributes the weight load on the main body of a street wrecker through a rigid support device. During the lifting operation with a heavy object, the two-section stretchable inner arms inside the underlift assembly will fully extend, and the cross bar on the top of the third-section pushing against the third section of boom will increase the supporting force and hence enhancing the rigidity of said boom. In addition, the auxiliary hydraulic winch system may facilitate the swing weight balance upon the lifting operation with a heavy object, so that it is able to improve the security and decrease the potential loss during the process of lifting the wrecked objects. In light of the above advantages, thus, the present invention not only is more reliable and but also is capable of improving the relevant operator's effectiveness at work, extend overall equipment service life as well as strengthening operational safety consequently.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a structural schematic view showing the present invention that is installed on a street wrecker;

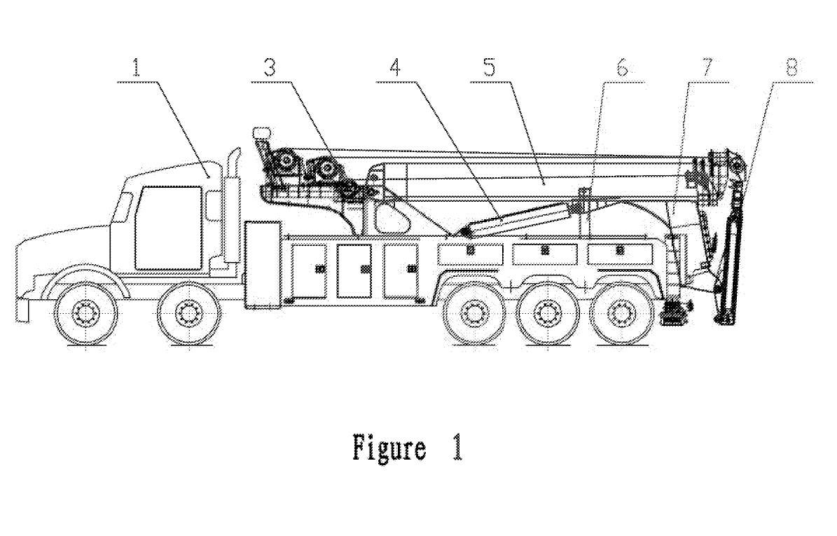

FIG. 2 is a schematic view showing the working status of a hydraulic winch system provided by the present invention;

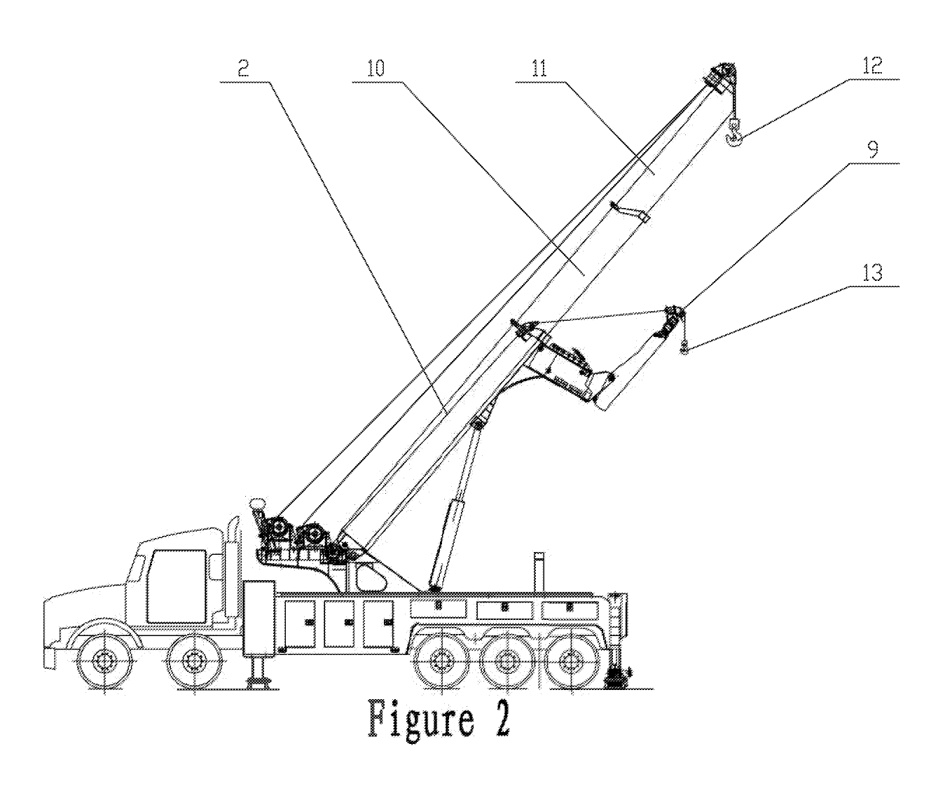

FIG. 3 is a structural schematic view showing a cross bar provided by the present invention;

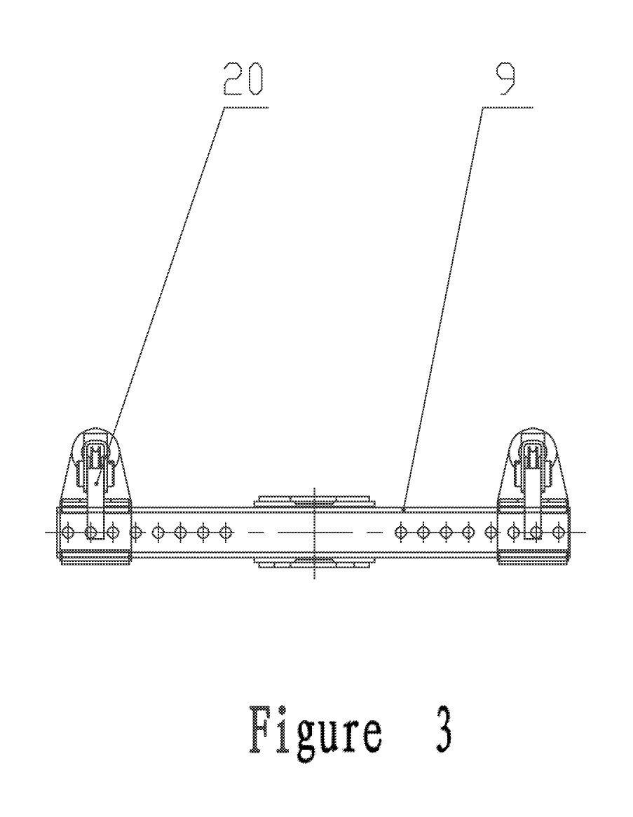

FIG. 4 is a schematic view showing the working status of the present invention;

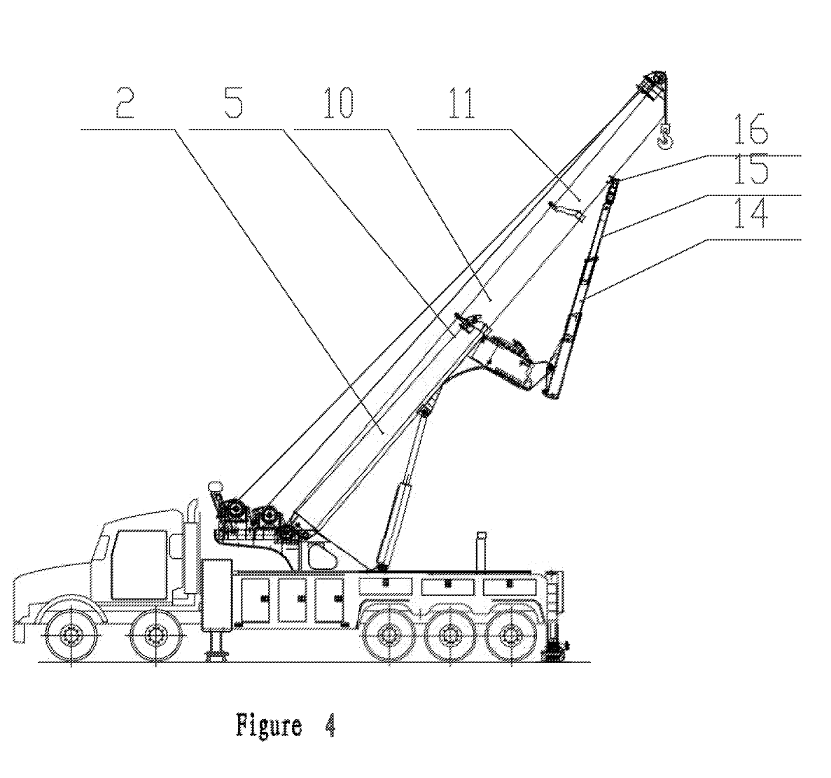

FIG. 5 is a schematic view showing the extended status of a two-section vertical arm in accordance with the present invention; and

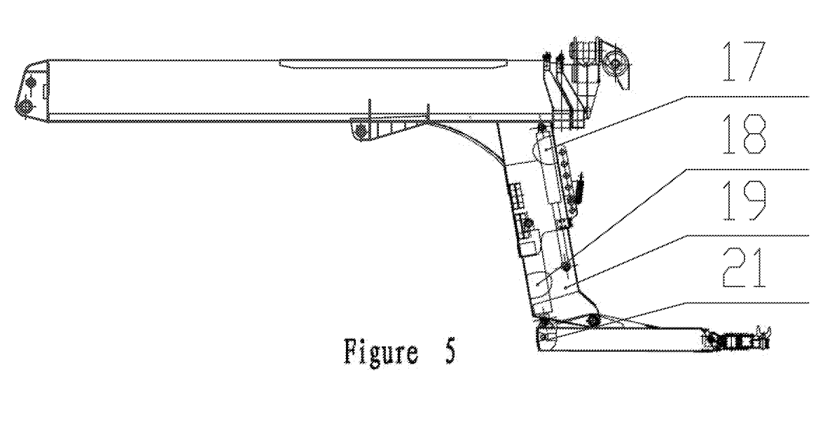

FIG. 6 is a schematic view showing the retracted status of a two-section vertical arm in accordance with the present invention.

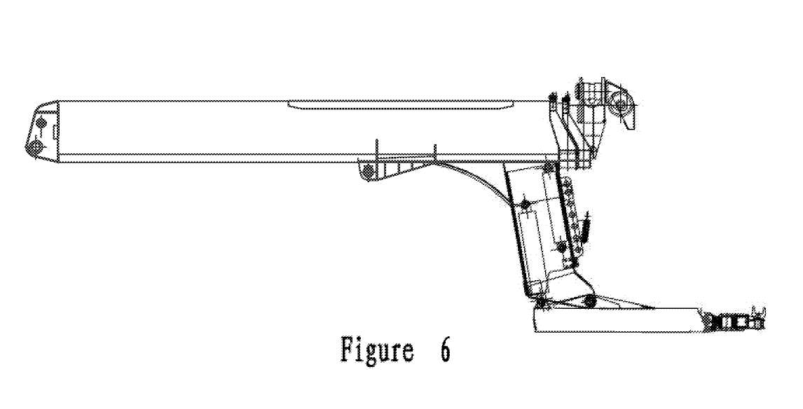

FIG. 7 is a schematic view showing a six side boom on support device.

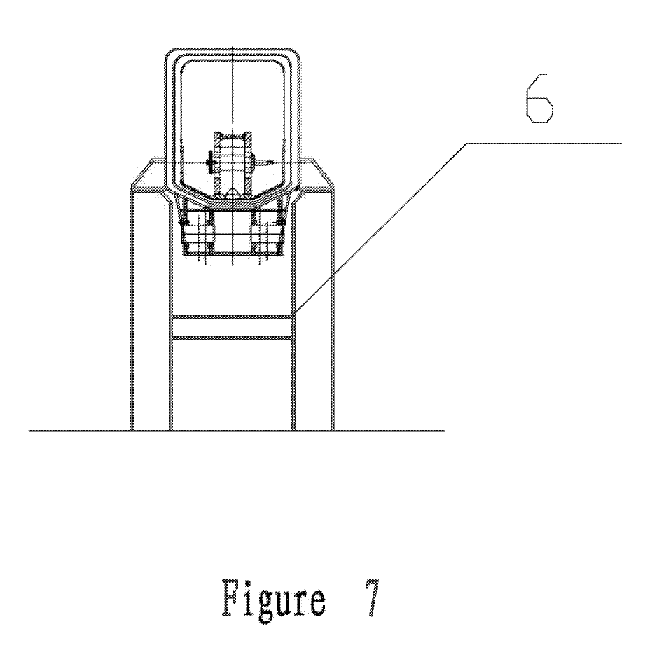

FIG. 8 is a schematic view showing the street wrecker towing the wrecked object.

### DETAILED DESCRIPTION OF THE PREFERRED EMBODIMENT

With reference to relevant drawings, it is shown that there is a stretchable first inner boom (second section) 10 and a secondary inner boom (third section) 11 being installed respectively inside the boom assembly 5. The supporting device 6 used to support the boom/underlift assembly 5 locates on the central line between the last two rear wheels of a street wrecker. The vertical arm assembly 7 having height adjustable type vertical arm 19 is welded at the end of the first section of boom assembly 5; in addition, the underlift assembly 8, which is fastened at the vertical arm assembly 7, comprises the first inner arm (second section) 14 and a secondary inner arm (third section) 15. There is an auxiliary hydraulic winch system consisting of auxiliary winch 3, and cross bar 9 is fixed at the end of the underlift assembly 8. Each side of the cross bar 9 on auxiliary lifting hooks 13 has been equipped with one guide pulley 20 respectively; and furthermore, there are wire ropes 2 passing through the auxiliary winch 3, guide pulleys 20 and auxiliary lifting hooks 13; and wherein, the hydraulic cylinder system consists of a plurality of hydraulic cylinders that have been installed inside the boom assembly 5, the vertical arm assembly 7 and the underlift assembly 8 respectively. Consequently, the design will be able to functionally activate and control the operations of extending outward or retracting inward for the relevant operational arms.

The boom assembly 5 is installed, via a pivot positioned at the boom base (turret) on the vehicle, together with the hydraulic cylinder 4 at the sub-frame on the street wrecker 1, and the boom/underlift assembly 5 will be laid on the rigid supporting device 6 during the lockout time period. When the street wrecker is arriving at its working site; the first, both the front and rear supporting legs of the street wrecker 1 will completely stretch out to stabilize the main vehicle body; the next, the boom assembly 5 will be raised gradually by the hydraulic cylinder 4 to a preset operational angle, and then the boom assembly 5 will be ready for operation while both the first inner boom (second section) 10 and secondary inner boom (third section) 11 have been fully stretched out by its internal hydraulic cylinder. Afterward, the underlift assembly 8 will start to operate immediately to drive the underlift in a direction parallel to the boom, and meanwhile the wire ropes 2 on the auxiliary winch 3 will pass through the guide pulleys 20 installed at the cross bar 9 and then be fastened along with auxiliary lifting hooks 13 to both sides of the wrecked object while main lifting hook 12 of the boom assembly 5 is successfully connected at a stress point of the wrecked object. During the period of lifting operation, the wrecked object is lifted up by the main lifting hook 12. The auxiliary lifting hooks 13 which extend a much longer distance at higher position than the conventional device catches the wrecked object and then works simultaneously with the main lifting hook. The combined results significantly increase both balance and stability of the wrecked object to prevent any accident, and hence, it is able to ensure the wrecked object will be move out of the ditch or steep slope stably and safely.

Once the wrecked object has been moved from the incident site to a site that is suitable for work, it is able to take off the auxiliary lifting hooks 13, whenever it is necessary, and then completely stretching out both the first inner arm (second section) 14 and the secondary inner arm (third section) 15 inside the underlift assembly 8 to a preset angle to allow the cross bar 9 at the top end to push against the bottom portion of the secondary inner boom (third section) 11 and under this circumstance, it will be able to operate the main lifting hook 12 to hand up the wrecked object then. Once the first inner boom (second section) 10 and the secondary inner boom (third section) 11 have been stretched out completely, while the underlift assembly 8 is extended completely, and the cross bar 9 at the front end will push against the central portion of the secondary inner boom (third section) 11 so as to construct a structure with triangle support. As a result, this unique structure enhances the stability of the secondary inner boom (third section) 11, especially during the strongly windy working environment.

Hereby, once the wrecked object has been moved to a suitable site for work, both the first inner boom (second section) 10 and secondary inner boom (third section) 11 will be retracted completely back to the main cylinder of boom and under this circumstance, the boom assembly 5 will be laid on the rigid supporting device 6. The height adjustable type vertical arm 19 will be dropped down to the ground by the hydraulic cylinder-I 17 installed inside the vertical arm assembly 7, meanwhile, the underlift assembly 8 will be dropped down to the ground by the hydraulic cylinder-II 18, and the hydraulic cylinder-III 21 installed inside the underlift assembly 8 will drive both the first inner arm (second section) 14 and secondary inner arm (third section) 15 to stretch out completely so as to lay the cross bar 9 equipped at the bottom end onto an appropriate position over the wrecked object, and afterward, it will be able to use an auxiliary tool 16 to tie up the wrecked object. Since the vertical arm assembly 7 and the underlift assembly 8 is able to stretch out to its maximum position on the ground respectively, so it is convenient for the operator to enter into the area underneath a low-chassis street wrecker, and at this moment, it is available to lift up the wrecked object and transport it to another location safely while using the hydraulic cylinder-II 18 to raise both underlift assembly 8 and cross bar 9 and also using the hydraulic cylinder-I 17 to raise the height adjustable type vertical arm 19 synchronously; in addition, it is able to insert a bolt into a safety pin hole to weaken the operating pressure of the hydraulic cylinder-I 17 for a smooth transportation.

Upon arrival at a predetermined destination, firstly, it needs to activate the hydraulic cylinder-I 17, release the safety bolt, and then operating both the hydraulic cylinder-I 17 and hydraulic cylinder-II 18 to drop down the height adjustable type vertical arm 19 and laying the underlift assembly 8 down to the ground. After releasing the connection between the underlift assembly 8 and the wrecked object, it will be able to retract back both the first inner arm (second section) 14 and secondary inner arm (third section) 15 and the underlift assembly 8 will restore idle status. Under this condition, it is able to retract height adjustable type vertical arm 19 and accomplishing the whole operation by inserting the specific safety bolt.

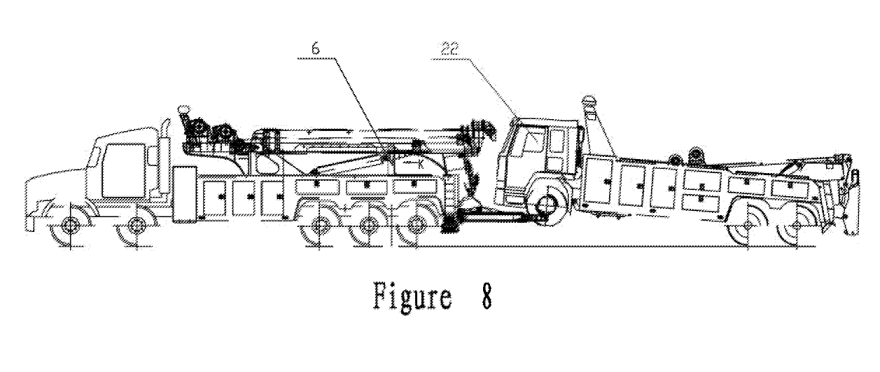

During the period of transportation with a wrecked object 22 (See FIG. 8), the boom/underlift assembly lies on a support device which acts as a fulcrum. The fulcrum is relocated from the end of sub-frame to a preferable spot 6. Such a favorable change greatly improves the balance of the leverage function. Consequently, the result improves the stress distribution on sub-frames of a wrecker while the load applies to the boom/underlift assembly 5 through vertical arm and underlift. Such a favorable pressure distribution will be able to provide a more comfortable operating condition and improve the wearing condition of driving wheels by reducing the weight of the street wrecker 1 itself, because it is not necessary to add a heavier corner weight to the front end of a street wrecker in order to maintain the balance for such a street wrecker again.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An integrated boom/underlift assembly comprises:
a boom assembly;
a hydraulic winch system;
a vertical arm assembly;
an underlift assembly;
a support device; and
a hydraulic cylinder system,
wherein a stretchable first inner boom and a secondary inner boom is installed respectively inside the boom assembly;
the vertical arm assembly having a height adjustable type vertical arm is welded at an end of a first section of the boom assembly;
the underlift assembly comprises a first inner arm and a secondary inner arm;
the hydraulic winch system comprises one cross bar fastened at an end of the underlift assembly, and an auxiliary lifting hook, in which each side of the cross bar has been equipped with a guide pulley respectively, and wire ropes pass through the auxiliary hydraulic winch system, the guide pulley and the auxiliary lifting hook; and
the hydraulic cylinder system consists of a plurality of hydraulic cylinders installed inside the boom assembly, the vertical arm assembly and the underlift assembly, to be able to activate and control operations of extending outward or retracting inward of relevant operational arms.

2. The boom/underlift assembly according to claim 1, wherein the support device is used to support the boom/underlift assembly; and the support device is equipped at an intersection of the centerline between two rear wheels and a centerline of a tailboard of a street wrecker.

3. The boom/underlift assembly according to claim 1, wherein a leverage mechanism of the support device can be applied to at least one of: a wrecker with only one rear axle, a wrecker with one or two rear axles, and a wrecker with two or three rear axles; and
a location of support device will cover from a tailboard to the center of a chassis of the wreckers.

4. The boom/underlift assembly according to claim 2, wherein a leverage mechanism of the support device can be applied to at least one of: a wrecker with only one rear axle, a wrecker with one or two rear axles, and a wrecker with two or three rear axles; and
a location of support device will cover from a tailboard to the center of a chassis of the wreckers.

5. The boom/underlift assembly according to claim 1, wherein the vertical arm assembly is integrated with the boom and has at least two stages for height adjustment.

6. The boom/underlift assembly according to claim 1, wherein the boom/underlift assembly and the support device are installed in a tow truck.
